(19) United States
(12) Patent Application Publication
(10) Pub. No.: US 2014/0367622 A1
(43) Pub. Date: Dec. 18, 2014

(54) DISPLAY MEDIUM AND COLOR REFLECTIVE INKS

(71) Applicant: PLIED NANOTECH HOLDINGS, INC., Austin, TX (US)

(72) Inventors: Zvi Yaniv, Austin, TX (US); Valerie Kaye Ginsberg, Austin, TX (US)

(73) Assignee: APPLIED NANOTECH HOLDINGS, INC., Austin, TX (US)

(21) Appl. No.: 14/374,656

(22) PCT Filed: Jan. 28, 2013
(86) PCT No.: PCT/US13/23430

§ 371 Date: Jul. 25, 2014

Related U.S. Application Data
(60) Provisional application No. 61/591,566, filed on Jan. 27, 2012.

(51) Int. Cl. C09D 5/33

(52) U.S. Cl. CPC C09D 5/004; C08L 2207/53
USPC 252/586

(57) ABSTRACT

Reflective color inks are used, such as for signage applications and as an electronic display medium and material. The reflective color inks comprise a core-shell particle that includes a core particle coated with a molecular surface coating. One example of such a particle is using a core of a polystyrene type of material that has a relatively low refractive index, with a high reflective index acrylic copolymer added as the shell material.

This application claims priority to U.S. Provisional Patent Application Ser. No. 61/591,566, which is hereby incorporated by reference herein.

### BACKGROUND INFORMATION

The technologies for flexible displays and signage are developing rapidly. For example, Qualcomm Inc. has implemented a reflective display, referred to as its mirasol display (see http://www.qualcomm.com/mirasol/technology). At the most basic level, a mirasol display is an optically resonant cavity. The device consists of a self-supporting deformable reflective membrane and a thin-film stack (each of which acts as one mirror of an optically resonant cavity), both residing on a transparent substrate. When ambient light hits the structure, it is reflected both of the top of the thin-film stack and off the reflective membrane. Depending on the height of the optical cavity, light of certain wavelengths reflecting off the membrane will be slightly out of phase with the light reflecting of the thin-film structure. Based on the phase difference, sonic wavelengths will constructively interfere, while others will destructively interfere. The human eye will perceive a color as certain wavelengths will be amplified with respect to others. The image on a mirasol display can switch between the selected color and black by changing the membrane state. This is accomplished by applying a voltage to the thin-film stack, which is electrically conducting and is protected by an insulating layer. When a voltage is applied, electrostatic forces cause the membrane to collapse. The change in the optical cavity now results in constructive interference at ultraviolet wavelengths, which are not visible to the human eye. Hence, the image on the screen appears black. A full-color display is assembled by spatially ordering IMOD (“interferometric modulator display”) elements reflecting in the red, green, and blue wavelengths.

Electronic paper, e-paper, and electronic ink (“E-ink”) are display technologies designed to mimic the appearance of ordinary ink on paper. Unlike conventional backlit flat panel, displays, which emit light, electronic paper displays reflect light, like ordinary paper, theoretically making it more comfortable to read, and giving the surface a wider viewing angle compared to conventional displays. Electronic paper was first developed in the 1970s by Nick Sheridon at Xerox's Palo Alto Research Center. The first electronic paper, called Gyricon, consisted of polyethylene spheres between 75 and 106 micrometers across. Each sphere was a janus particle composed of negatively charged black plastic on one side and positively charged white plastic on the other (each bead was thus a dipole). The spheres were embedded in a transparent silicone sheet, with each sphere suspended in a bubble of oil so that they could rotate freely. The polarity of the voltage applied to each pair of electrodes then determined whether the white or black side was face-up, thus giving the pixel a white or black appearance. In the simplest implementation of an electrophoretic display, titanium dioxide (titania) particles approximately one micrometer in diameter are dispersed in a hydrocarbon oil. A dark-colored dye is also added to the oil, along with surfactants and charging agents that cause the particles to take on an electric charge. This mixture is placed between two parallel, conductive plates separated by a gap of 10 to 100 micrometers. When a voltage is applied across the two plates, the particles will migrate electrophoretically to the plate bearing the opposite charge from that on the particles. When the particles are located at the front (viewing) side of the display, it appears white, because light is scattered back to the viewer by the high-index titania particles. When the particles are located at the rear side of the display, it appears dark, because the incident light is absorbed by the colored dye. If the rear electrode, is divided into a number of small picture elements (pixels), then an image can be formed by applying the appropriate voltage to each region of the display to create a pattern of reflecting and absorbing regions. A problem with such E-ink in e-readers (electronic readers) is that they are monochromic, generally black and white, and suffer from many disadvantages, such as lack of color, lack of speed, etc.

Also existing is a signage using a reflective type of material. Examples are road signs, which generally are white letters on a green background. Many highway transportation and signage experts have expressed a need for having these signs in different colors so they may display not only location information, but also warnings, existence of parks, existence of rest stops. etc.

### BRIEF DESCRIPTION OF THE DRAWINGS

FIG. 1 illustrates a Bragg reflection device in accordance with embodiments of the present invention.

FIG. 2 illustrates a particle configured in accordance with embodiments of the present invention.

FIG. 3A shows digital images of reflective color ink applied to glass substrates.

FIG. 3B shows digital images of reflective color ink applied to PET substrates.

FIG. 4 shows a digital image of reflective color ink applied to a dark substrate.

FIG. 5 illustrates an electrophoretic display technology.

FIG. 6A illustrates a process for making an electrophoretic display in accordance with embodiments of the present invention.

FIG. 6B illustrates operation of an electrophoretic display in accordance with embodiments of the present invention.

### DETAILED DESCRIPTION

This application discloses technologies for new reflective inks, such as for signage applications and as an electronic display medium and material.

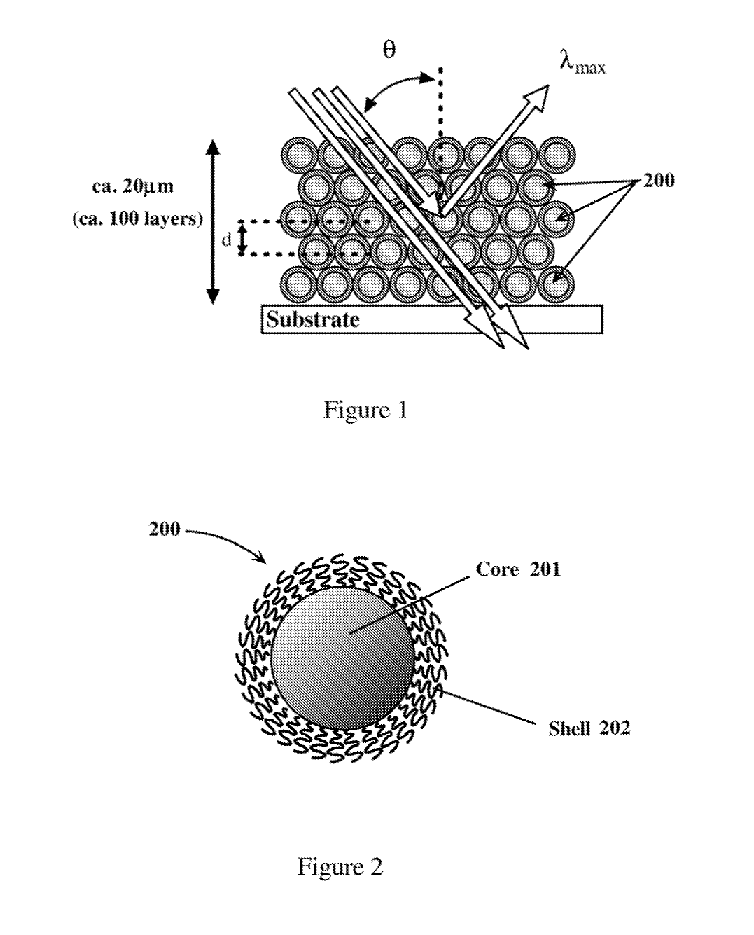

Bragg reflections are well known in x-ray imaging of crystal structures, for example. the ordered atom locations in layers with a certain periodicity create specific reflections of a predetermined wavelength that depend on the periodicity of the crystal and other factors. A similar process to Bragg reflections can be repeated with visible light instead of x-ray if an organized structure as described above is constructed as shown in FIG. 1.

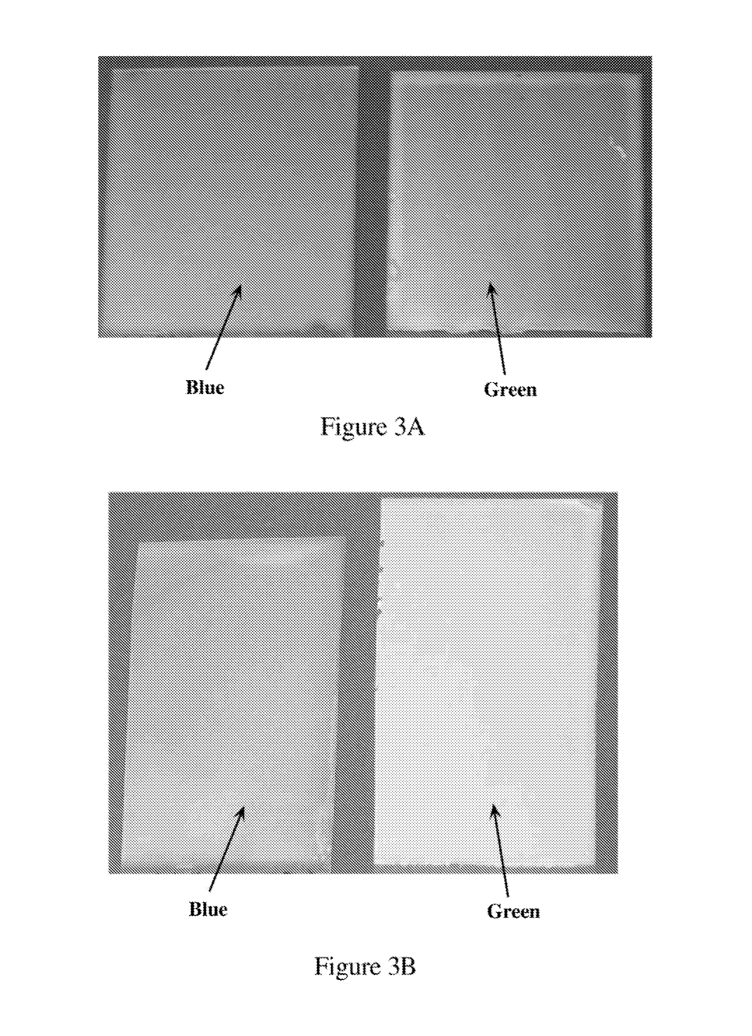

FIG. 2 shows a core particle 201 coated with a molecular surface coating 202. To create Bragg reflections as shown in FIG. 1, for example, the diameters of the particles 200 may be between 100 and 300 nanometers, having a low reflective index such that each particle has a shell component 202 of a high refractive index with the shell thickness between 10 and 100 nanometers. Other types of combinations can be engineered and implemented. However, as further noted herein, though the particles can be engineered at various dimensions of core diameter and shell thickness, for producing a Bragg reflection film, these dimensions need to he substantially similar for each of the particles to be utilized in the film.

One example of such a particle is using a core of a polystyrene type of material that has a relatively low refractive index, with a high reflective index acrylic copolymer added as the shell material. A process for obtaining this type of material with Uniform size distribution may utilize coating techniques of organic/inorganic composites and suitable polymerization techniques such as, for example, the ones utilized by NOF Corporation in Japan by grafting reactions of polymer or by graft polymerization of a monomer on the top of the polystyrene particles. Other materials can be chosen and other coating techniques can be used, such as spraying, evaporation, spattering, etc.

For example, commercially available particles were obtained from NOF Corporation, identified with the product name IC-20, which were engineered according to the requirements disclosed herein by the inventors and produced into an ink solution. Each ink generally comprised an acryl ester polymer, an acryl ester monomer, a solvent (e.g., 2-propanol, 1-methoxy-, 2-acetate), and additives (e.g., photo-initiator, etc.) at various percentages (for example, the polymer may be approximately 20-30%, the monomer may be approximately 30-45%, the solvent may be approximately 12-40%, and the additives may be approximately 2-15%). A first ink composition sample no. IC-20 Green had an approximate particle diameter of 220 nm with a peak wavelength of 540 nm, thus showing a generally green reflectance. A second ink composition sample no. IC-20 Blue had an approximate particle diameter of 190 nm with a peak wavelength of 480 nm, thus showing a generally blue reflectance. A third ink composition sample no. IC-20 Red had an approximate particle diameter of 240 nm with a peak wavelength of 600 nm, thus showing a generally red reflectance. Of course, embodiments of the present invention are not limited to such peak wavelengths for possible ink compositions.

The following embodiment may be utilized for making core-shell particles in accordance with embodiments of the present invention. Polystyrene particles with highly uniform diameter are synthesized using micelles. A micelle is created when a surfactant having a polar end group and non-polar end group on the opposite end aggregate into a spherical shape. A micelle occurs when polar end groups are positioned on the outside of the sphere and interact with a polar solvent such as water. In this case, the inside of the spherical shape is non-polar. An inverse micelle occurs when non-polar groups assemble to the outside of the spherical shape and interact with a non-polar solvent. In this case, the inside of the spherical shape is polar. Micelles will have a very well defined inner cavity based on the particular surfactant used and its non-polar molecular chain length. Micelles can help dissolve non-polar materials into polar solvents. For example, a styrene monomer is dispersed in an aqueous micelle solution. The styrene monomer is then polymerized inside the micelle center. When polymerized, the polystyrene maintains the shape of the interior of the micelle. The finite size of the micelle provides highly uniform polymerized styrene (polystyrene) beads. The micelles outer surfactant coating can be removed by a washing technique or through application of heat.

The uniform beads are then coated with a secondary surface to make the shell component. This surface may be made of linear chain hydrocarbons. The linear chains can be found with varying lengths dependent on the number of carbons that make up the chain length. Typical carbon chain lengths range from 6 to greater than 24 carbons. The ends of these linear chain hydrocarbons may be derivatized with a reactive end group. The polystyrene particle coating (shell component) may also be based on additional branched polymer structures.

Important for proper functioning of visible Bragg reflections is that the thickness of this particle coating is uniform such that the interparticle spacing is held constant throughout the cured sample.

In the case described above with respect to FIG. 1, the specific wavelength reflected λₘₐₓ is:

λₘₐₓ=2(d/m)(n²−sin²θ)^{1/2}

wherein λₘₐₓ is the peak wavelength, d is the lattice spacing of the crystal, n is the effective refractive index, and m is the order of the Bragg reflection.

As can be observed, in addition to the angle dependence that may be problematic in certain applications, two parameters determine the wavelength of the radiation reflected: (1) the lattice spacing, d, which depends on a radius, or diameter, of the core-shell particle 200, and (2) the effective refractive index, n. As a result, the nature of the materials used for constructing the core-shell particles 200, and the thickness of the core 201 as well as the thickness of the shell 202 determines the reflected wavelength.

Two types of core-shell particles 200 were commercially obtained from NOF Corporation with specific wavelengths with green and blue reflections utilized as a prime material dispersed in an ink vehicle comprised of a mixture of organic solutions to satisfy the quality of dispersion needed and secure the proper viscosity for coating (e.g., with a draw down technique) (e.g., the M46 and M50 ink compositions previously disclosed). After the ink described above is coated on a substrate, it may be dried by thermal or other means such as CV cross-linking (e.g., if CV cross-linking agents are added to the ink solution).

In building construction, glass that has specific reflections may be utilized (e.g., with greenish, brownish, or bluish reflections, etc.). These reflections are typically created by coating the glass with a thin film of material, generally utilizing relatively expensive processes (e.g., evaporation or spattering in a vacuum), and as a result the final product is costly.

An alternative to the costly process described above is to coat the glass substrate with specific reflective inks as described herein, which can be executed directly on the glass substrate or can be applied aftermarket (e.g., by adhering a transparent polymer (e.g., PET) coated with specific reflective inks as described herein).

Other techniques of attaching or other coating techniques (e.g., spraying, deep coating, etc.) may be used.

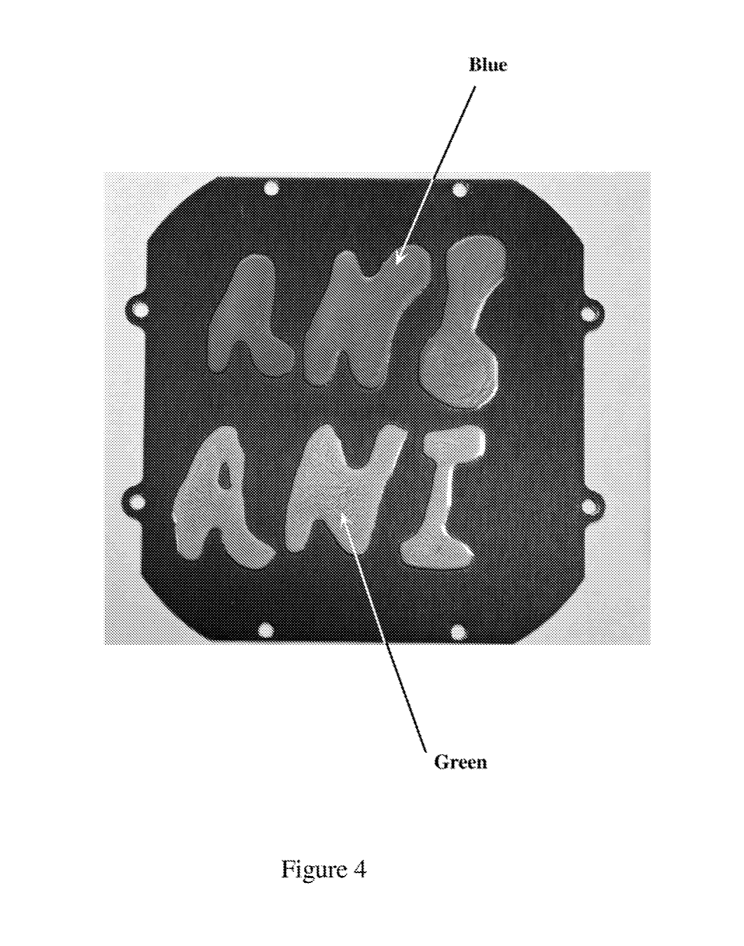

For example, a drawdown machine may be used to apply reflective color ink onto PET and glass substrates, such as shown by the results shown in FIGS. 3A-3B. Metal applicator rods may be wound with wire of varying diameters, depending upon the wet film thickness required. The coating passes through the gaps between the wires, and levels of at a uniform thickness. Different wire diameters will yield wet film thicknesses of ·6-230 microns. A #30 rod (0.76 mm diameter) may be used for these samples to produce a ·76 micron wet film. After drying and curing with UV light, the film is ·30 micron thick. Reflective color ink may be used at different thicknesses, depending upon the optical properties required. Many other techniques may be used to apply precise “blanket coat” thicknesses of reflective color ink (e.g., Bird Type Film Applicators, Universal Blade Applicator, Micrometer Film Applicators). Other “blanket film” application techniques include airbrush, spin-coat, gravure, flexography, inkjet, screen or stencil printing, various configurations of continuous flow/multi-nozzle fluid dispensers, aerojet, and offset lithography. Some of these processes can be used in a “roll to roll” application.

Reflective color ink may be also applied in a patterned array (e.g., using a simultaneous, 3-axis control, desktop dispenser). Other application techniques may be used with reflective color ink to produce patterned arrays, including gravure, flexography, inkjet, screen or stencil printing, aerojet, and other fluid dispenser systems with x-y axis control.

Reflective color ink may be processed onto many different types of substrates including glass, PET, PC, and fabrics.

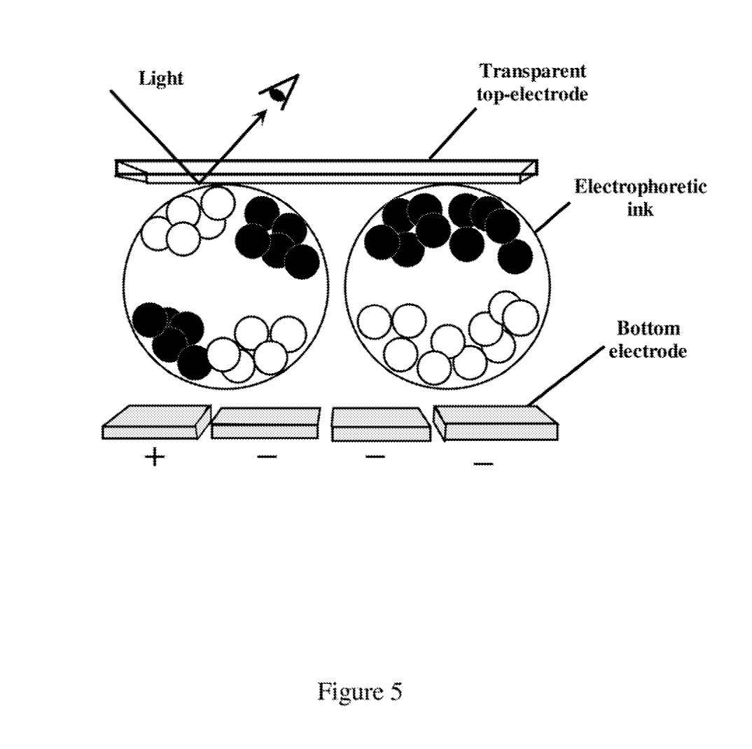

A similar reflective color ink deposited on a dark (e.g., black) background (i.e., substrate) with a higher thickness provides an excellent color reflection quality such that this color reflective ink can be utilized for color reflective signage applications. In FIG. 4, the letters “ANI” were applied by hand on a dark substrate showing excellent reflection quality as described herein. For example, the reflective color ink may be applied to a substrate with a pipette (e.g., by hand), bake dried, and UV cured.

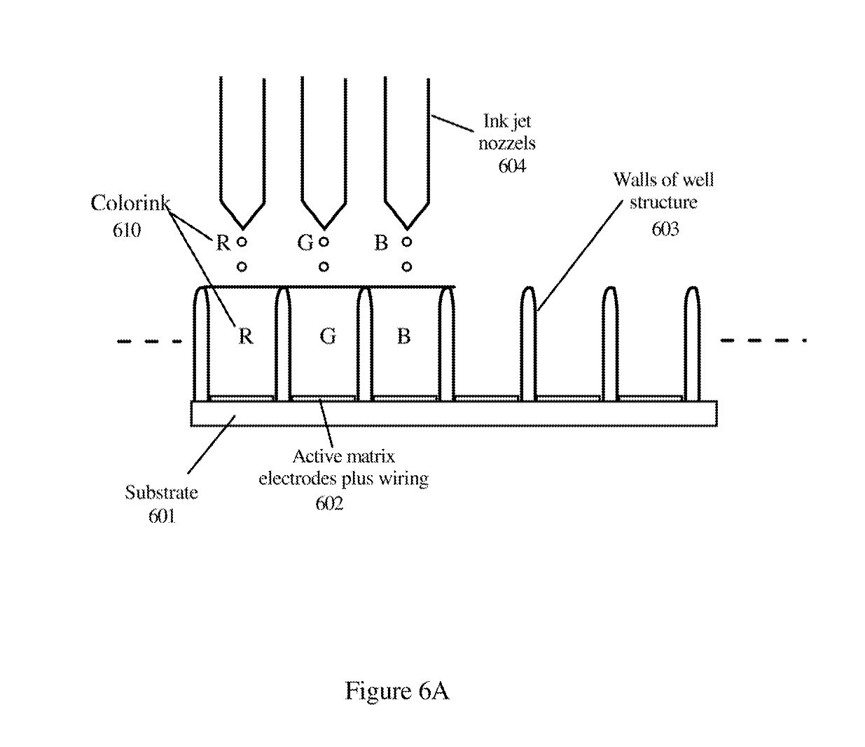

The reflective color inks described herein may be utilized as a new material for reflective electronic displays. Electrophoretic technology is the base of E-ink types of displays. The simplest case of an electrophoretic display is a black and white display. The electrophoretic ink used for this type of display is a mixture of transparent liquid and microscopically charged pigment particles. The usual choice is negatively charged black particles (e.g., carbon black) and positively charged white particles (e.g., TiO₂) wherein the ink is captured inside microcapsules as shown in FIG. 5. When a voltage is applied, as demonstrated in FIG. 3, the charged pigments move due to an electrostatic force to the attracting electrode. For example, when the bottom electrode is positive, it will attract black particles and repel white particles. These white particles gather at the top electrode where they reflect incident light in all directions, obtaining a white state. Changing the polarity of the voltage in a similar way obtains a black state. And, as shown, a combination black/white state can be achieved. The particles treated as such will have a good suspension in the liquid.

Embodiments of the present invention utilize such electrophoretic, or charged, particles (e.g., TiO₂ particles as the core) and coat a color shell component thereon in a similar manner as described above with respect to the core-shell particles 200 utilized for reflective inks, or any other combinations between electrophoretic types of particles and/or Bragg reflection technology described above. For example, utilizing such a process, embodiments of the present invention can achieve a green on white display, blue on white display, red on white display, etc., or any combination thereof. When the material is continuous between the two substrates of the display, this will be basically a monochrome display. On the other hand, by utilizing a variation of the well structure described in U.S. Pat. No. 5,281,450 (which is hereby incorporated by reference herein), we can achieve isolated pixels for each color, and in such a way obtain a full color display using the color reflective ink as described herein.

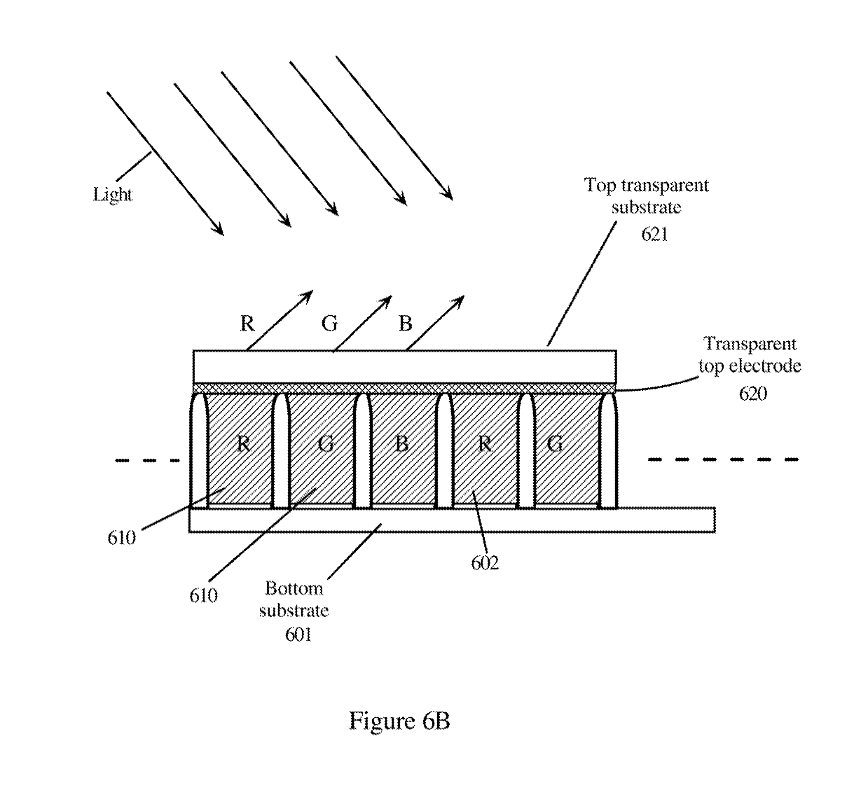

Referring to FIG. 6A, the particles may treated with charging agents to give them an electric charge. Following the teaching in U.S. Pat. No. 5,281,450, and other similar patents and publications, we can, for example, use inkjet nozzles 604 to inkjet the color reflective inks 610 of each desired color (e.g., red R, green G, and blue B) between the walls 603 of each well structure, and using, for example the electrophoretic mode as described above, achieve a full color display in the reflective mode.

Referring to FIG. 6B, the bottom substrate 601 may be of any material that is compatible with the process and operation for passive or active matrix electrodes 602, 620. The top substrate 621 is transparent (e.g., solid such as glass or a transparent polymeric substrate such as PET). Accordingly, one can obtain a rigid or flexible display using this type of color reflective ink as described herein. Using electrophoretic technology, a color reflective display is produced, which will reflect incident light in accordance with the patterns produced by the matrix addressable electrodes 602, 620 in a manner well-known in the art. For example, a typical RGB display can be realized.

By varying the size of the core and the thickness of the shell, the reflected wavelength λₘₐₓ may be tuned in the infrared (IR), ultraviolet (UV), and other specific wavelengths. As a result one can obtain a layer that reflects infrared or a layer that reflects ultraviolet, for many types of applications.

What is claimed is:

1. A composition comprising a reflective color ink deposited on a substrate, the reflective color ink further comprising core-shell particles each comprising a core coated with a shell of linear chain hydrocarbons, wherein the core-shell particles have diameters configured to produce a predetermined reflectance of wavelength of visible light from the reflective color ink.

2. The composition as recited in claim 1, wherein the diameters of the core-shell particles are substantially uniform within the reflective color ink.

3. The composition as recited in claim 1, wherein the substrate is glass.

4. The composition as recited in claim 1, wherein the substrate is plastic.

5. The composition as recited in claim 1, wherein the substrate is clear plastic.

6. The composition as recited in claim 1, wherein the core-shell particles form a Bragg reflection surface on the substrate reflecting the predetermined reflectance of wavelength of visible light.

7. The composition as recited in claim 1, wherein the core is an electrophoretic particle.

8. The composition as recited in claim 1, wherein the core is a charged particle.

9. The composition as recited in claim 1, wherein the core is a polystyrene type of material having a first refractive index, and the shell is an acrylic copolymer having a second refractive index higher than the first refractive index.

10. The composition as recited in claim 1, wherein the substrate is of a dark color.

11. The composition as recited in claim 1, wherein the substrate has a black color.
